(19) United States
(12) Patent Application Publication
(10) Pub. No.: US 2016/0081307 A1
(43) Pub. Date: Mar. 24, 2016

(54) CONTAINER FOR THE TRANSPORT OF LIVE POULTRY

(71) Applicant: ZANOTTI Massimo, Gussago (Brescia) (IT)

(72) Inventor: Massimo ZANOTTI, Gussago (Brescia) (IT)

(21) Appl. No.: 14/786,920

(22) PCT Filed: Apr. 24, 2014
(86) PCT No.: PCT/IB2014/060982

§ 371 Date: Oct. 23, 2015

(30) Foreign Application Priority Data
Apr. 26, 2013 (IT) TO2013A000343

(51) Int. Cl. A01K 31/00; B65G 69/00; B65G 49/00

(52) U.S. Cl. CPC A01K 31/002; B65G 49/00; B65G 69/00

(57) ABSTRACT

Described herein is a container (1) for transport of live poultry (P), including a surface provided at least in part with openings (20, 200, 201, 21; 40, 400, 401, 41). The container (1) includes an access opening (100) having a first, open, configuration for introduction of a bird into the container (1) and a second, closed, configuration for the confinement of the bird introduced into the container, and is shaped and sized for containing just one bird (P) inside it.

### FIELD OF THE INVENTION

The present invention relates to containers for the transport of birds, in particular to containers for the transport of type poultry.

### PRIOR ART

The poultry-slaughtering industry relies not only on machinery capable of carrying out slaughtering of poultry, but also and above all on the logistic chain upstream of the slaughtering activity itself. In this connection, the transport of the poultry from the breeding site to the slaughtering site is of fundamental importance.

In order to maximize the profitability of each transport, it is preferable to move large amounts of poultry on lorries or trucks generally resorting to quadrangular supporting frames and drawer-type cages open at the top and inserted in a condition where they are arranged on top of one another in the frame.

An example in this sense may be found in document EP-1330952B1, of which the present Applicant is co-inventor, whereby the drawer-type cages can be slid out through a first side of the frame in a partially extracted condition to enable loading of the poultry according to a procedure that envisages first filling of the lower drawer kept inserted in the supporting frame, then re-insertion into the supporting frame of the immediately overlying drawer so as to close the lower drawer at the top, and then repetition of the above steps for each drawer until the top drawer is filled, which is finally closed at the top by a lid applied on top of the frame.

However, transport of poultry with these modalities presents a series of drawbacks, basically caused by the high density of poultry that characterizes each load.

In the first place, overcrowding of the poultry crammed into the drawer-type cages stacked in the loading compartment of a transport vehicle cannot guarantee optimal conditions of ventilation for the animals, thus increasing the fraction of poultry that dies during transport.

Furthermore, some birds may die of suffocation or hyperthermia in so far as the strict vicinity with other birds leads to a general rise in the temperature of the air, this situation being aggravated by the fact that very often the warmest part of the animal, which is the breast, is squeezed against a contiguous animal.

The ensemble of these factors constitutes a serious problem in so far as, if the journey from the breeding site to the slaughtering site is very long, the risk of losing part of the load of poultry is high.

### OBJECT OF THE INVENTION

The object of the present invention is to overcome the drawbacks and the technical problems mentioned previously.

In particular, the object of the invention is to provide a container for the transport of birds, in particular poultry, that will ensure for each animal an optimal ventilation and will simplify the operations of loading and unloading of the poultry.

### SUMMARY OF THE INVENTION

The object of the invention is achieved by a container for transport of poultry having the features forming the subject of one or more of the ensuing claims, which font an integral part of the technical disclosure provided herein in relation to the invention.

In particular, the object of the invention is achieved by a container for transport of birds, in particular poultry, including a surface provided at least in part with openings, the container being characterized in that it includes an access opening having an open configuration for introduction of a bird into the container and a closed configuration for confinement of the bird introduced into the container, and in that the container is shaped and sized for containing a single bird inside it.

### BRIEF DESCRIPTION OF THE DRAWINGS

The invention will now be described with reference to the attached figures, which are provided purely by way of non-limiting example and wherein:

FIG. 1 is a perspective view of a container for the transport of birds according to a preferred embodiment of the invention;

FIGS. 2 and 3 are perspective views of components of the container of FIG. 1;

FIG. 4 is a perspective view of the container of FIG. 1, but showing a different, configuration of use;

FIG. 5 is a schematic representation in side view of a container according to the invention and of a bird housed therein;

FIG. 6 is a schematic front view of a number of containers according to the invention, each housing a bird, said containers being arranged in the transport configuration;

FIG. 7 is a top plan view of a plurality of containers according to the invention, each container housing a bird, and said containers being arranged in the transport configuration;

FIG. 8 is a schematic side view according to the arrow VIII of FIG. 7;

FIG. 9 is a schematic view illustrating the arrangement of the containers according to the invention in the loading compartment of a transport vehicle; and

FIG. 10 is a view similar to that of FIG. 6 but illustrating areas of circulation of the air between the containers in conditions of transport.

### DETAILED DESCRIPTION OF EMBODIMENTS OF THE INVENTION

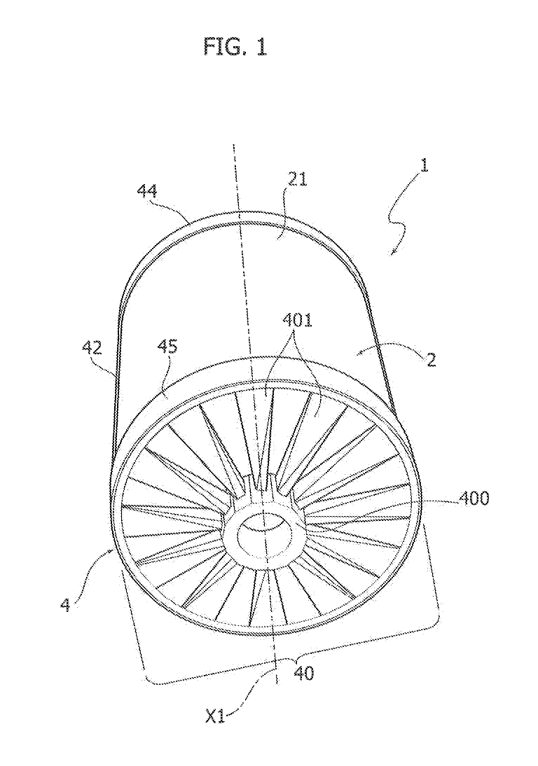

With reference to FIG. 1, number 1 designates as a whole a container for the transport of birds, in particular poultry, according to a preferred embodiment of the invention. The container 1 includes an inner body 2 and an enter body 4 fitted on the inner body 2 and mounted rotatable with respect thereto. The outer body 4 is coaxially fitted on the inner body 2 with respect to a longitudinal axis X1 of the container 1.

Each of the two, outer and inner, bodies is basically defined by a surface of revolution; i.e., it has a geometry defined by the revolution of a generatrix about an axis in this case the axis X1.

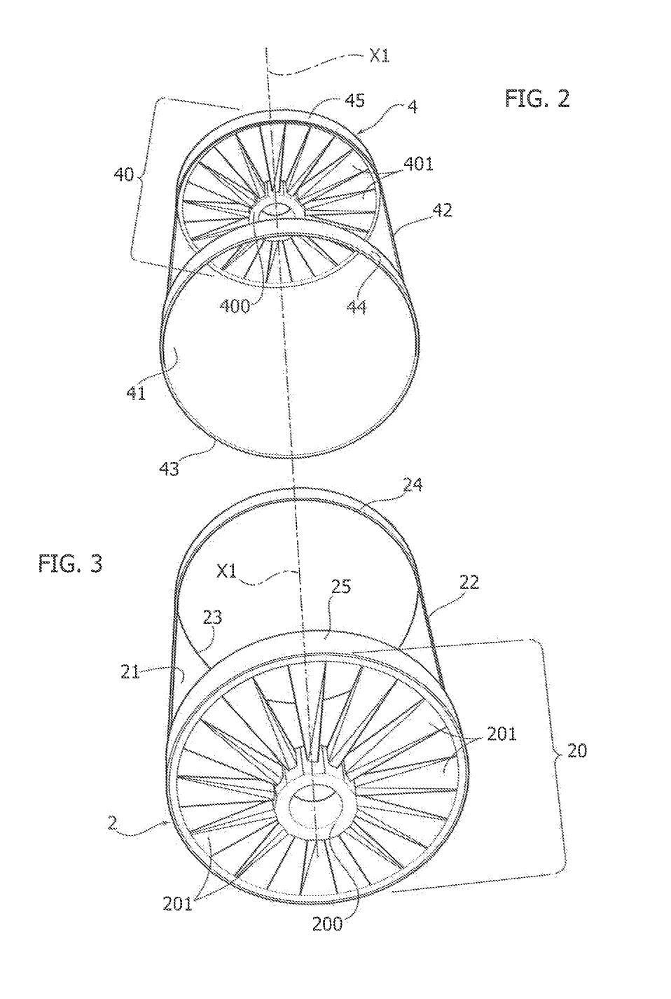

With reference to FIGS. 2 and 3, the inner body 2 and the outer on body 4 are configured as elements having a cylindrical geometry such that one fits into the other and have diameters that are only minimally different from one another, so that insertion of the inner body 2 into the outer body 4 will provide a radial play sufficient only to enable a relative rotation between the two bodies but not an appreciable misalignment thereof.

The inner body 2 includes a base surface 20 having an apertured structure and set at a first end of the inner body. The body 2 moreover includes a lateral surface 21 interrupted by a window 22, the angular extension of which is preferentially chosen in the range from 140° to 160°; a preferred value is 150°.

A second end 23 is, instead, completely open and preferentially provided at said end is a circular edge 24 that extends substantially in a bridge-like fashion between the sides of the window 22. Once again preferably, also provided at the base surface 20 is a circular edge 25 similar to the edge 24.

The base surface 20 may in general have any apertured structure of a known type, for example a grid-like structure with quadrangular, circular meshes, or the like, but in the preferred embodiment illustrated herein, the apertured structure is defined by a hub 200 coaxial to the axis X1, from which a plurality of spokes 201 with radial orientation depart, which defines a geometry altogether identical to that of an automotive spoke wheel.

In a way similar to the inner body 2, the outer body 4 includes a base surface 40 having an apertured structure and set at a first end of the inner body. The body 4 moreover includes a lateral surface 41 with cylindrical shape interrupted by a window 42, the singular extension of which is preferentially equal to that of the window 22; i.e., it fails within the same range of amplitudes mentioned above and is characterized by the same preferential value of amplitude.

A second end 43 of the outer body 4 is instead completely free, and preferentially provided at said second end is a circular edge 44, similar to the edge 24, which extends substantially in a bridge-like fashion between the sides of the window 42.

Once again preferentially, a circular edge 45 similar to the edge 44 is provided at the first end where the base surface 40 is present. Also in this case, the base surface 40 can assume any apertured structure of a known type, but in the preferred embodiment illustrated herein the aperture structure (in a way identical to the case of the base surface 20) is defined by a central hub 400, from which a plurality of spokes 401 with radial orientation depart.

As may be appreciated from the ensuing description, each of the hubs 200, 400 projects and defines a spacer element configured for co-operating with a homologous hub of an adjacent container when a plurality of containers 1 are stacked in the loading compartment of a transport vehicle.

The hubs 200, 400 are here represented as elements substantially shaped like a bushing with polygonal outer surface and cylindrical inner surface. In alternative embodiments, it is possible for both of the surfaces to be cylindrical (smooth), or even other geometries may be envisaged. For instance, the outer surface could be provided as the toothing of an external gear wheel in order to favour coupling and interaction with automated handling machinery (see hereinafter for further details).

Both of the bodies 2, 4 are made of strong plastic material (such as Keviar, carbon fibre, glass fibre, HDPE, or polycarbonate) or metal material or both (for example, the base surfaces are made of plastic material and the lateral surfaces of each body 2, 4 are made of metal material).

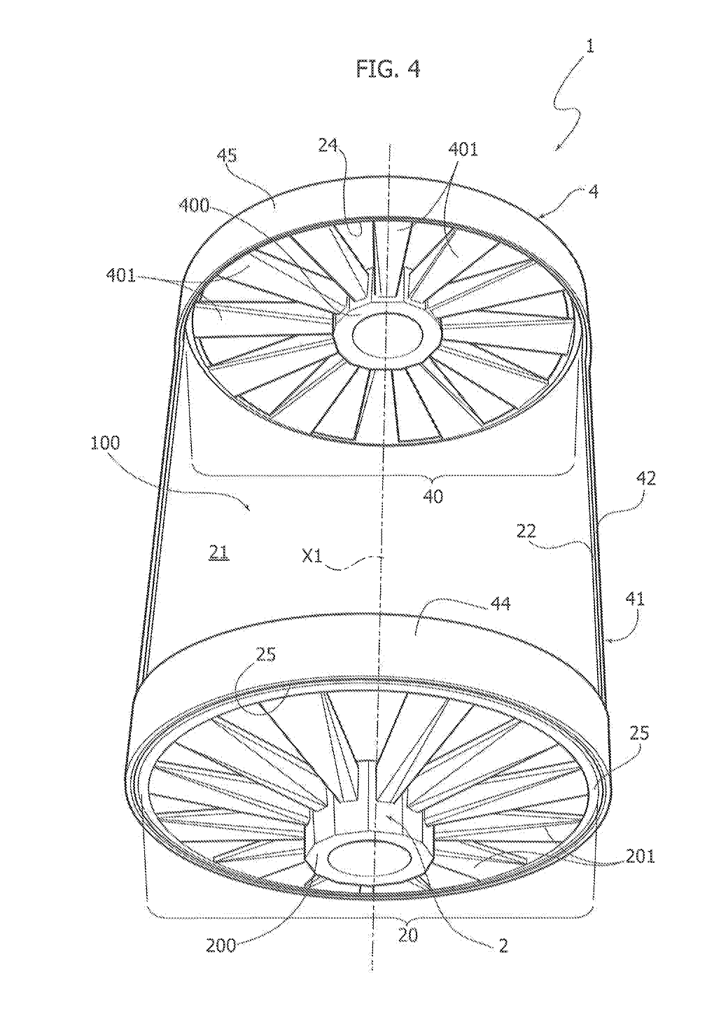

The bodies 2 and 4 constitute two modular units of the container 1 and are assembled together to obtain the configuration illustrated in FIG. 1 or in FIG. 4. Assembly of the container 1 envisages that the outer body 4 will be fitted on the inner body 2 so that the open end 43 is located substantially in a region corresponding to the base surface 20 of the inner body 2, and vice versa; i.e., also the free end 23 of the body 2 must be located substantially in a region corresponding to the base surface 40 of the body 4. Fitting of the two modular units together is obtained by axially sliding one into the other until the circular edge 24 of the end 23 bears upon the base surface 40.

It should moreover be noted than the fit between the two bodies actually creates a container, which includes:
the inner body 2;
the outer body 4, which is fitted on the inner body 2 and is rotatable with respect thereto;
a first end surface 20 having an apertured structure; and
a second end surface having an apertured structure.

With reference to FIG. 4, the container includes an access opening 100 that is set between the first and second end surfaces. As may be seen in FIGS. 1 and 4, the access opening 100 includes an open configuration illustrated in FIG. 4 and a closed configuration illustrated in FIG. 1. Each of the two aforesaid configurations is determined by the conditions of covering of the window of one of the two bodies and the lateral surface of the other body.

In greater detail, the open configuration of FIG. 4 corresponds to a situation in which the relative position between the inner body 2 and the outer body 4 is such that an at least partial alignment occurs between the windows 22, 42 of the bodies 2, 4, i.e., a condition such that at least one region of the overall lateral surface of the container 1 exists which is not covered by the lateral surfaces 21 and 41, which consequently leaves a window open that defines the access opening 100. FIG. 4 illustrates a very particular condition, wherein it is assumed that the windows 22, 42 have the same angular extension. In the condition of FIG. 4, the radial alignment between the windows 22, 42 is total, i.e., no substantial covering of one of them by the lateral surface of the other body exists. It is clearly a preferred configuration in so far as it guarantees the largest dimensions possible for the access opening 100, which facilitates introduction of a bird inside the container 1.

Instead, FIG. 1 illustrates a configuration in which the opening 100 is closed and wherein a covering of the window 42 on the lateral surface of the outer body 4 by the lateral surface 21 of the inner body 2 occurs. The covering needed for achieving complete closing of the access opening 100 is of the total type.

Switching between the open configuration and the closed configuration of the opening 100 takes place by relative rotation of the inner body 1 with respect to the outer body 4 (or vice versa). Mounting of the inner body 2 within the outer body 4 with a slight radial play has precisely this purpose in so far as in the absence of such a condition it would be impossible to easily impart rotation on one of the two bodies in order to switch the opening 100 between the two configurations.

Preferentially, an operator who has the task of introducing a bird into the container 1 can operate by keeping one of the ends 20, 40 stationary (with the aid, for example, of the hub 200, 400) and rotating the other apertured end by exerting a force for example on one of the spokes 201, 401 in order to vary the configuration of the access opening 100. It should be noted that, unlike systems of transport of a known type, the container 1 is shaped and sized for receiving just one bird inside it.

The sequence of introduction of a bird into the container 1 envisages opening the container (if it is closed) by impressing a relative rotation on the two bodies 2, 4 in order to bring the access opening 100 into the open configuration, inserting the bird into the container through the opening 100, and closing the container itself by impressing again a relative rotation on the two bodies 2, 4 so as to close the opening 100.

The dimensions of the access opening 100 can in any way foe modulated by varying the covering between the lateral surfaces and the windows of the two bodies 2, 4. Only when total covering occurs are the windows 21, 41 completely closed, and hence no access opening is present on the overall lateral surface of the container 1.

Nevertheless, the person skilled in the art will appreciate how the structure of the container 1 well lend itself to facilitating the operations of opening and closing thereof by a mechanized and automated machinery configured for coupling with the hubs 200, 400 in order to impart the relative rotation to the bodies 2, 4. In this regard, if the outer surface of the hubs is shaped like the toothing of an external gear wheel it will be possible to couple the container 1 in a machine with a handling assembly that is provided with a toothing capable of meshing with the toothing provided on the hub. Instead, in the case where the outer surface of the hubs is polygonal, a shape fit will be possible with a machine provided, for example, with a hollow rotary head of a complementary shape.

In this regard, with a view to optimize the poultry loading and unloading process, automated machines may be provided both at the poultry loading facility (e.g. the breeding site) and at the poultry unloading facility (e.g. the slaughterhouse). Any of such machine may be programmed according to a specific set of instructions corresponding to loading and unloading operation.

The automated machine at the poultry loading facility may be configured for performing the following sequence of steps:

1L) picking the container 1 (already in assembled condition, i.e. with the bodies 2, 4 coupled with each other),

2L) coupling with the hubs 200, 400 of the container 1,

3L) rotating the whole container around the longitudinal axis X1 until a reference position is reached wherein the window 22, 42 of one of the two bodies 2, 4, is oriented upwards in the vertical direction; in this respect, it is preferable to rotate the container 1 so as to bring into the reference position the window 22, 42 of the body (either 2 or 4) which is intended to be maintained fixed in rotation during the subsequent poultry loading operation. In order to provide a reference for the machine, each nub may be provided with one or more indicia (e.g. a notch, a relief, or even optically detectable indicia) representative of the position of the respective windows 22, 42; note that the access opening 100 is thus oriented upwards in the vertical direction,

4L) rotating the body (either 4 or 2), which is intended to be movable during poultry loading operation, around the longitudinal axis X1 by an amount-sufficient to bring the access opening 100 into the closed configuration, thereby completing the loading operation by confining the bird within the container 1.

In the sequence above it is assumed that the container 1 enters the machine in the fully open configuration during poultry loading operations in so far as the containers are generally left open for washing after an loading.

If this were not to be the case, the machine could be nevertheless configured to detect partly opened configurations of the container 1 and to perform preliminary alignment operations no achieve full opening of the container 1.

The bird is loaded between steps 3L) and 4L) above.

An analogous sequence of steps may be performed at the poultry unloading facility, wherein the automated machine (which may me identical to that at the loading facility, save for the different set of instructions to be executed) may be configured for performing the following sequence of steps

1U) picking the container 1 housing a respective bird P,

2U) coupling with the hubs 200, 400 of the container 1,

3U) rotating the whole container around the longitudinal axis X1 until a reference position is reached wherein the window 22 or 42 of one of the two bodies 2 or 4, is oriented downwards in the vertical direction; in this respect, it is preferable to rotate the container so as to bring into the reference position the window (22 or 42) of the body (2 or 4) which is intended to be maintained fixed in rotation during the poultry unloading operation. Reference for the machine is provided in the same way as previously mentioned in respect of the poultry loading operation,

4U) rotating the body (4 or 2) f which is intended to be movable during poultry unloading operation, around the longitudinal axis X1 so as to bring the access opening 100 into the open configuration to allow exit of the bird P from the container 1; note that, on account of the alignment carried out at the preceding step, the access opening 100 is oriented downwards in the vertical direction, so that the bird P may simply drop onto a receiving area or facility under the force of gravity.

As anticipated, the container 1 is preferably left with the access opening 100 in the open configuration after unloading of the bird P, so as to facilitate the subsequent washing operations thereof.

Note also that the machines at the loading and unloading facilities may be exactly identical, with the sole difference lying in the different set of instructions which is executed. More conveniently, each machine may be provided with both sets of instructions (i.e. for loading and unloading poultry) which can be selected by the user according to the needs (i.e. for loading or unloading poultry).

In other embodiments, however, the container 1 may be slightly modified in order to further optimize the automated loading and unloading of the poultry.

One of the two bodies 2 or 4 may be provided with two windows 22 or 42 set at diametrically opposite locations.

The other body (4 or 2), on the contrary, will remain unmodified with respect to what described in the foregoing.

The skilled person will readily appreciate that with such an arrangement an access opening 100 is created in the container 1 twice in a complete rotation of one body 2, 4 with respect to the other (being maintained fixed). This because, assuming preferentially that the body with a single window gets rotated around the longitudinal axis X1 during loading and unloading operations, the window on the rotating body will align a first time with a first window on the other body, thereby defining an access opening, and a second time with a second window on the other body, thereby defining another access opening at a diametrically opposite location. Preferably, all the windows on both bodies 2, 4 extend along a 90 degree angle (i.e. along an arc that subtends a 90 degree angle).

This means that the above sequences of steps for automated loading and unloading of the poultry may be made substantially identical and corresponding to the following sequence:
i) picking the container 1 (empty in the event of poultry loading, loaded in the event of poultry unloading)
ii) coupling with the hubs 200, 400 of the container 1,
iii) rotating the whole container 1 around the longitudinal axis X1 until a reference position is reached wherein the two diametrically opposite windows of one of the two bodies (2 or 4), are oriented along the vertical direction; in this respect, the body having the two windows (either 2 or 4) shall be maintained fixed in rotation during poultry loading/unloading operations. Reference for the machine is provided in the same way as previously described,
iv) rotating the body (either 4 or 2) which is intended to be movable during poultry loading/unloading operations by 90 degrees around the longitudinal axis X1: this will either result in the access opening being closed for the confinement of the bird within the container during poultry loading or in the access opening being opened to enable the exit of the bird P from the container 1 during poultry unloading; note that, on account of the alignment carried out at the preceding step, either access opening is oriented along the vertical direction.

Again, in the sequence above it is assumed that the container 1 enters the machine in the fully open configuration during poultry loading operations (in so far as the containers are generally left open for washing after unloading). If this were not to be the case, the machine could be nevertheless configured to detect partly opened configurations of the container 1 and to perform preliminary alignment operations to achieve full opening of the container 1. In the event of poultry loading, the bird would be loaded between steps iii) and iv) above.

Note also that, in order to avoid dropping of the bird while the latter is in an upside down position (the two windows of the container are in fact symmetrical), the angular indicia provided on the hubs 200, 400 may also be configured in order to univocally identify “up” and “down” sides in the container, so that the latter is loaded and unloaded always with the same orientation, thereby ensuring that the bird drops therefrom on its legs.

For the execution of the above described sequences of operations, each automated machine may for example be equipped with a manipulation assembly including two rotating heads, each configured for the coupling with a corresponding one of the hubs 200, 400. For instance, the above mentioned heads may be configured for achieving a shape coupling, or a coupling by means of conjugate profiles, or even a coupling by interference (e.g. by means of grippers). The two rotating heads may be both of an active type, that is, provided with autonomous motorization and locking/braking devices, and independently actuated so as to provide the machine with a maximum of feasibility. However, in certain embodiments it is possible that one of the two heads be of a passive type, that is not provided with an autonomous motorization, but mounted freely rotatable (idle) and provided solely with a rotation locking/braking device. In this way the other head, the active one, will perform all the operations which involve the rotation of the container 1 in its entirety or of one of the bodies 2 or 4. The passive head—instead—will only be locked and unlocked, respectively depending on the fact that the body 4 or 2 whose hub 400 or 200 is engaged therein is to be maintained fixed in rotation (steps 4L), 4U) and iv), head locked) or is to be made freely rotatable (steps 3L), 3U) and iii), head unlocked).

In the event of a machine having active and passive heads, care should be taken when handling the slightly modified container (i.e. that having two windows on one body and consequently two access openings) in that the hub of the body having two windows be coupled to the passive head.

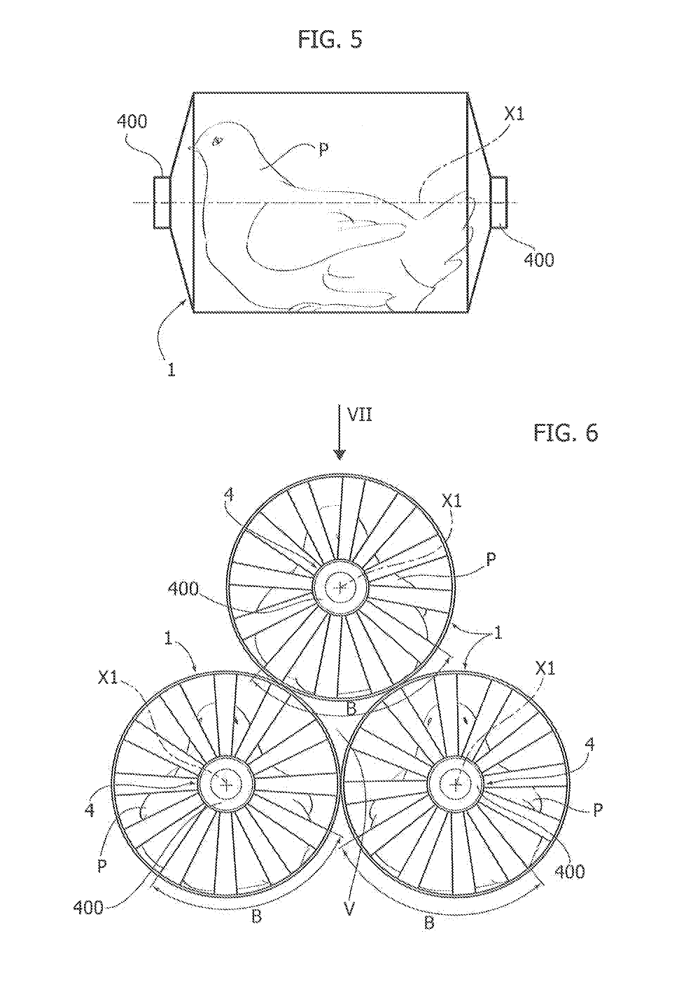

With reference to FIG. 5, the schematic illustration shows a bird P, in particular a chicken, inside the container 1. The container 1 has radial dimensions such as to enable the bird to assume the crouched posture, in any case leaving a space available to the animal to allow small movements. Preferentially, the dimensions are chosen in such a way that the animal cannot manage to assume the upright posture in so far as this could constitute a of harm to the bird if it were to lose its balance arid roll over owing to vibrations, jolts, jerks, etc. during transport. The preferential dimensions of the container 1 are chosen in the following ranges:
150 mm to 200 mm as regards the outer diameter,
24 cm and 30 cm as regards the axial length.

Given the average size of birds sent for slaughter, these dimensions enable housing of just one bird inside the container 1, thus guaranteeing a minimum degree of freedom of movement for the bird. The housing of plural birds would result, instead, substantially impracticable with the dimensions referred to above.

FIG. 5 eloquently illustrates the main advantage of the invention as compared to known solutions for transporting poultry: the chicken is confined within a closed space protected by the walls of the container 1, and any possible harm to the animal from other chickens is hence prevented.

More in general, the same purpose can be achieved, according to various embodiments of the invention, by any container for transport of poultry including a surface provided at least in part with openings and comprising an access opening for a bird, in which the access opening has a first, open, configuration for introduction of a bird into the container and a second, closed, configuration for confinement of the bird introduced into the container. As has already been mentioned, the container is shaped and sired, for containing a single bird. The shape may be cylindrical as in the case of the container 1 or even polygonal, for example quadrangular.

The structure provided with openings of the container ensures at the same time confinement and optimal ventilation for the animal. Preferentially, at least the longitudinal axial ends of the container (with reference, respectively, to a longitudinal axis or direction thereof) have a structure provided with openings for favouring ventilation.

The preferred embodiment appearing in the figures presents, however, yet further advantages in terms of ventilation of the animals and in terms of practicality of stacking of the containers within the loading compartment of a transport vehicle, as will now be described in detail.

By way of example, FIG. 6 illustrates three containers 1, each containing a chicken P, stacked according to a quincunx-type arrangement, i.e., arranged on top of one another in alternating rows of n and n-1 containers.

The containers of each row support the weight of all the containers of the higher rows, and contact between containers develops basically along the lateral surface thereof.

The structure provided with openings of the end surfaces of the container guarantees an optimal ventilation of the poultry in an axial direction (considered with respect to the container 1): there is in fact defined, in each container, a radial arrangement of ventilation areas, each comprised between two adjacent spokes 201, 401.

Furthermore, the tangency between the containers 1 identifies further ventilation areas designated by the letter V and having a substantially tricuspidal cross section.

In addition to this, in FIG. 6 the area B identifies an angular portion of the container 1 on which the breast of the chicken rests, which, as has been mentioned, is the warmest part of the animal. Thanks to the containers 1, the area B where the breast of the chicken rests does not come into contact with other birds but is in contact only with other contiguous containers and moreover in areas where the breast of another bird is not present.

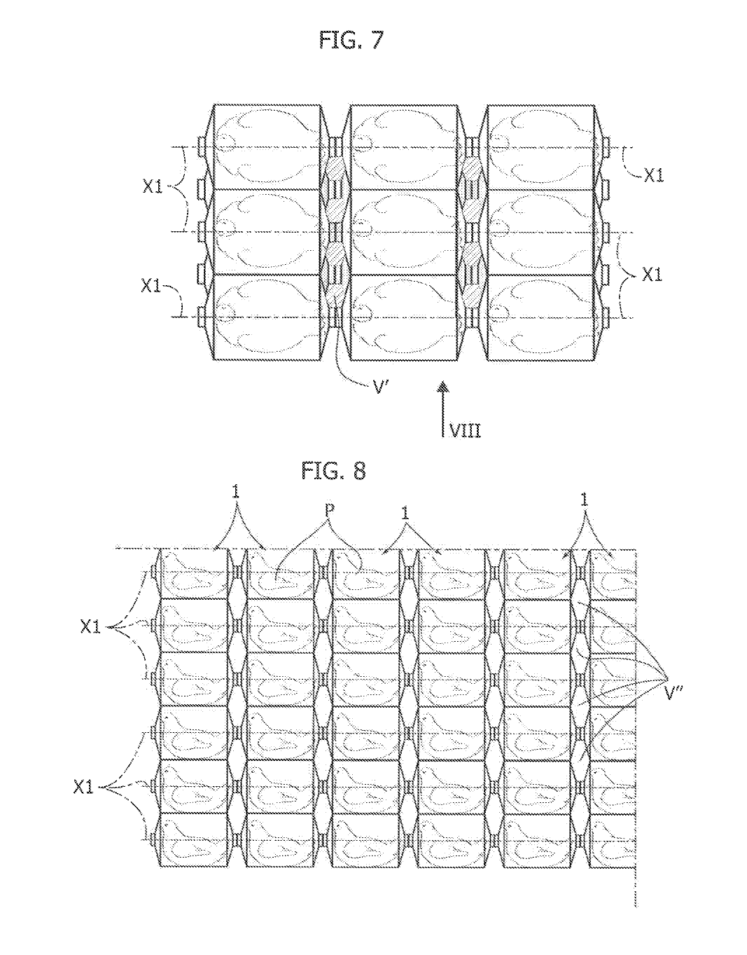

With reference to FIGS. 7 and 8, stacking of the containers 1 within the loading compartment of a transport vehicle, even though the containers 1 are arranged immediately adjacent to one another, enables the definition of corridors and passageways for air, which contribute to providing optimal ventilation of the animals. FIG. 7 in particular illustrates a top plan view from a point of observation that corresponds to the one indicated by the arrow VII in FIG. 6. Also in this case, ventilation columns V′ are defined, having a substantially hexagonal section (with local variations of section due to the arrangement of the containers: however, the hexagonal section constitutes a sort of “core” of the ventilation column) and defined between axially contiguous containers 1.

In this connection, it should be noted the action of the hubs 200, 400, which function as spacer elements: contact of the hubs along the axis of the container 1 ensures maintenance of a pre-determined axial distance between contiguous containers in order to prevent as far as possible any stagnation of air that might prove dangerous for the animals. As may be noted in FIGS. 5 and 7, the spokes 201, 401 are preferably shaped so as to project axially on the outside of the container, thus providing a pseudo-conical structure on the end surfaces 20, 40 and guaranteeing a further spacing effect. Of course, for this purpose it is possible to apply spacer elements at the end areas of the container according to the invention, also in the case where it is configured as a variant of the container 1 (i.e., in the case where it has a shape different from the cylindrical one and/or end surfaces with a structure provided with openings having a shape different from that of the container 1).

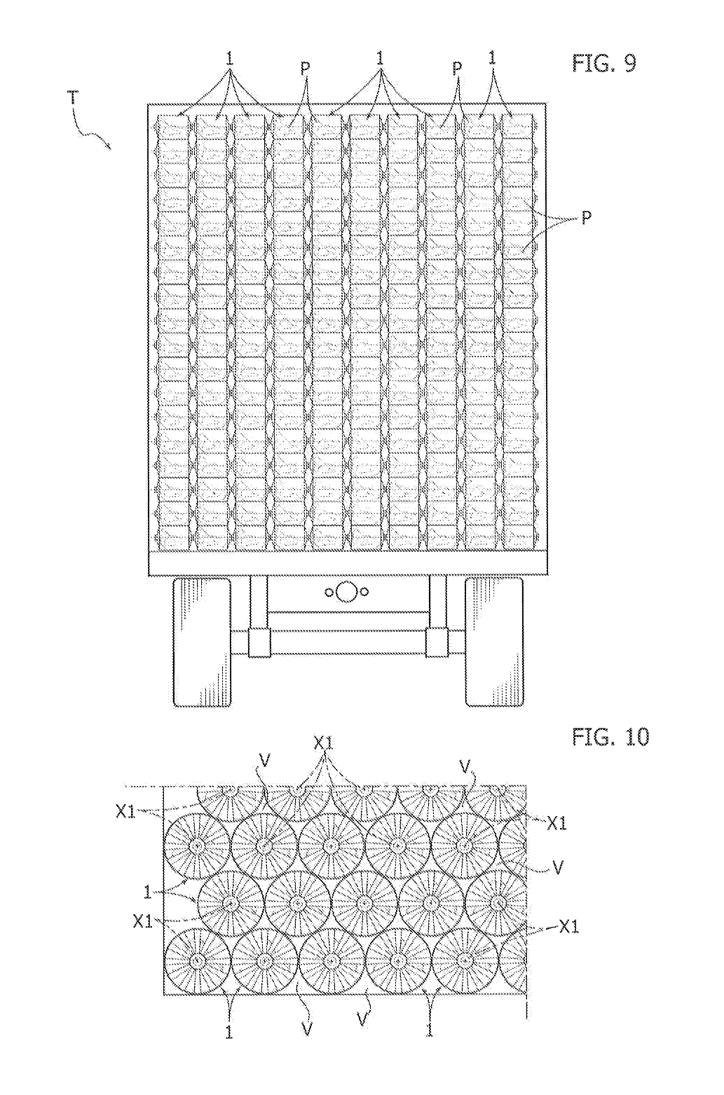

FIG. 8, which is a schematic view according to the arrow VIII of FIG. 7, shows how—in a transverse direction with respect to the ventilation columns V′—further ventilation corridors V″ are defined having a substantially hexagonal section. All the ventilation corridors associated to the regions V′ and V″ are oriented in a transverse direction with respect to the containers 1. Of course, according to the arrangement of the containers 1 in the loading compartment of a transport vehicle (see in this connection the following FIG. 9), it is possible for the regions V, V′ and V″ to assume orientations different from the direction of travel of the vehicle.

FIG. 9 illustrates the arrangement of a plurality of containers 1 within the loading compartment of a lorry: in this way, it is possible to appreciate the extreme rationality of the solution and the optimal exploitation of the loading space that is guaranteed by the containers 1, which at the same time afford an optimal protection for the animals during transport. Furthermore, the containers 1 ensure an individual space for each chicken in all conditions.

Finally, FIG. 10 shows how the ventilation regions V define a lattice of tricuspidal elements, located in the meshes of which are the radial patterns of ventilation areas comprised between adjacent spokes 201 (or 401). The person skilled in the art may thus appreciate that the overall front section (considered with reference to the axis of the containers 1) of the ventilation regions V constitutes a very consistent part of the total front section of the containers 1.

Of course, the details of construction and the embodiments may vary widely with respect to what has been described and illustrated herein, without thereby departing from the scope of the present invention, as defined by the annexed claims.

In particular, given that introduction of a bird into the container 1 is obtained by relative rotation of the two bodies in order to open and close the access opening 100, the same result can be achieved in different ways. For instance, the container 1 could be simply equipped with a hatch that can be opened and closed.

Furthermore, in some alternative embodiments, the outer body 4 may be provided with a hexagonal, octagonal, or in general polyhedral external geometry. This possibility is basically a response to the need to maintain more easily an assigned position for the container. In these embodiments, the body 4 would in any case maintain the cylindrical shape inside.

As regards, instead, the inner body 2, in this embodiment it would in any case present a substantially cylindrical geometry (both inside and outside) in order to enable rotation thereof with respect to the outer body 4 (which also, as has been said, would have a cylindrical geometry inside).

1. A container (1) for transporting live poultry (P), including a surface which is at least, in part apertured (20, 200, 201, 21; 40, 400, 401, 41), the container (1) being characterized in that it is sized and dimensioned to contain a single bird (P) therein, and in that it includes an access opening (100) having a first, open, configuration for the introduction of a bird into the container (1) and a second, closed, configuration for the confinement of the bird introduced within the container.

2. The container (1) according to claim 1, further having a substantially cylindrical shape.

3. The container (1) according to claim 1, further including ends with an apertured structure.

4. The container (1) according to claim 1, wherein a protruding spacer element (200, 400) is provided in correspondence of each of said ends having apertured structure and is configured to contact a homologous spacer element of another container (1) in a quinconce storage condition of the containers (1) in a pay load bay of a transport vehicle.

5. The container (1) according claim 1, including:
an inner body (2),
an outer body (4) fitted onto said inner body and rotatable relative thereto,
a first end surface (20) having apertured structure (200, 201),
a second end surface (40) having apertured structure (400, 401),
wherein each of said inner body (2) and outer body (4) includes a lateral surface (21,41) which is interrupted by a respective window (22, 42),
wherein the open configuration of said access opening (100) is defined by an at least partial alignment between the windows (22, 42) of the lateral surfaces (21, 41) of said inner body (2) and outer body (4), and wherein the closed configuration of said access opening (100) is defined by an overlap of the window (22) of the lateral surface (21) of the inner body (2) by the lateral surface (41) of the outer body (4), said access opening (100) being commutable from one to the other configuration by means of a relative rotation of said inner body with respect to said outer body (2, 4).

6. The container (1) according to claim 4, wherein each of said outer body (4) and inner body (2) includes:
a base surface (20, 40) having apertured structure (200, 201; 400, 401) located at a first end thereof,
the respective lateral surface (21, 41),
a second, open, end (24, 44),
wherein said outer body (4) is fitted onto said inner body (2) so that the open end (44) of the former is arranged in correspondence of the base surface (20) of the latter (2) and vice versa, so that the base surfaces (20, 40) having apertured structure define said first and second end surfaces of said container (1).

7. The container (1) according to claim 4, wherein each end having apertured structure (20, 40) includes a hub (200, 400) and a plurality of spokes (201, 401) departing from said hub (200, 400), said hub defining said spacer element.

8. A modular element (2; 4) for a container (1) for transporting live poultry (P), including:
a base surface (20: 40) having apertured structure (200, 201; 400, 401) located at a first end,
a lateral surface (21; 41) interrupted by a window (22; 42), and
a second, open, end (24; 44).

9. The modular element (2; 4) according to claim 8, wherein a spacer element (200, 400) is provided in correspondence of each open end (24; 44).

10. The modular element (2; 4) according to claim 8, having a substantially cylindrical geometry.

11. The modular element (2; 4) according to claim 8, wherein each base surface (20: 40) exhibits a centrally located spacer element (200, 400).

12. A method for transporting live poultry (P), characterized in that the birds are introduced into respective containers (1) which are operable and reclosable and which are each sized and dimensioned to contain a single bird (P), and in that said containers are loaded on a transport vehicle in close proximity with each other but so as to define ventilation passages therebetween.

13. A method for loading and unloading a container (1) according to claim 7, particularly by means of an automated machine, the method comprising the steps of:
picking the container (1),
coupling with the hubs (200, 400) of the container,
rotating the whole container along a longitudinal axis (XI) until a reference position is reached wherein the window (22, 42) of one of the two bodies (2, 4), is oriented along a vertical direction,
rotating the other body (4, 2) around the longitudinal axis (XI) by an amount sufficient to change the configuration of the access opening (100).

14. The method according to claim 13, wherein, during poultry loading operation, in the reference position said window (22, 42) is oriented upwards along the vertical direction, and the configuration of the access opening is changed from open to close, thereby confining a bird (P) within the container (1).

15. The method according to claim 13, wherein, during poultry unloading operation, in the reference position said window (22, 42) is oriented downwards along the vertical direction, and the configuration of the access opening (100) is changed from close to open, thereby allowing a bird (P) to exit from the container (1).
